(19) United States
(12) Patent Application Publication
(10) Pub. No.: US 2003/0235263 A1
(43) Pub. Date: Dec. 25, 2003

(54) Steam quality measurement using acoustic pressures

(76) Inventors: Veera Rajendran, Niskayuna, NY (US); Alan Maddaus, Rexford, NY (US); Richard E. Warren JR., Schenectady, NY (US); Nicholas Joseph Mollo, Clifton Park, NY (US)

Correspondence Address: NIXON & VANDERHYE P.C./G.E., 1100 N. GLEBE RD., SUITE 800, ARLINGTON, VA, 22201, US

(21) Appl. No.: 10/064,184

(22) Filed: Jun. 19, 2002

(51) Int. Cl. G21C 17/00

(52) U.S. Cl. 376/248

(57) ABSTRACT

A method of determining wetness fraction of steam vapor-water mixture in a flow path of a steam turbine includes: a) locating a plurality of acoustic pressure sensors at axially spaced locations along the flow path; b) measuring acoustic pressures from noise in the flow path; c) calculating the speed of sound of the vapor-water mixture; and d) calculating the mass fraction of water in the mixture from the speed of sound of the mixture.

### BACKGROUND OF INVENTION

this invention relates to steam turbine technology and specifically to the measurement of steam quality in the flow path of a steam turbine.

Steam quality (steam vapor fraction in the total flow) measurement is important in the turbine community for several reasons. Wet steam is a significant factor in nuclear powered steam power plants, and it is also encountered in low pressure turbine stages in fossil fired steam plants. In low pressure sections (commonly referred to as LP sections), as the pressure and temperature of the steam drop, water droplets form. Depending upon the size of the droplets, and the amount and content of water in the steam, performance of the turbine may be significantly adversely affected. For example, water present in steam causes erosion-corrosion of turbine blades which can severely limit the life of the turbine components, and may also affect the efficiency of the LP section. Despite the fact that wetness fraction is a significant factor in determining LP section efficiency, there are no methods presently available for measuring steam quality that are easy to use and that can be conveniently monitored.

Presently, there are several methods available to measure the wetness fraction of steam. Almost all of these methods, however, are handicapped by one shortcoming or another. Coarse water may be detected by mechanical separation and then measured. Sometimes probes with “absorbing pads” are inserted into the steam flow path to absorb the wetness. By measuring the weight of the pad before and after, the amount of water in the steam may be determined. In another technique, solutions of “tracers” (fine particles) with a known concentration may be injected into wet steam and by measuring the concentration in the steam sample, the water content may be calculated. Still another technique utilizes sodium/lithium salts or radioactive isotopes, but these are generally not recommended due to possible health hazards.

For fine water droplets (fog wetness fraction), light absorption or extinction methods are utilized. A light (visible, beta, ultraviolet or other) is passed through the steam sample, and by measuring the absorbed/extinctive light and comparing with the reference beam, the amount of water may be deduced.

All of these methods suffer from the need for prior calibration, since it is difficult to produce a steam sample with a particular composition or wetness fraction to utilize as a reference.

Thermodynamic methods such as throttling, heating, condensing and psychometric techniques use the principle of making the wet steam into dry steam and then calculating the wetness fraction by carefully balancing the energy inputs and outputs. For example, in the throttling method, the wet steam is expanded into dry steam at constant enthalpy (without temperature change). By enthalpy balance, wetness fraction is deduced. The heating method inputs a known amount of heat which is taken into account in the energy balance. Other thermodynamic methods follow the same general principle, but all suffer from lack of accuracy, and time scales required for the phase change process from water to vapor can be significant, thus rendering the measurement process time consuming, and non-indicative of real time distribution.

### SUMMARY OF INVENTION

In accordance with this invention, an array of pressure transducers/sensors are placed at appropriate locations in, for example, the exhaust section of the steam turbine (or other desired location in the steam flow path), and are used to measure acoustic pressures of the flowing medium, in this case steam comprising a vapor-water mixture. These sensors can be mounted so as to be non-intrusive as to the steam flow (for example, along the periphery of the exhaust section), or can be located directly in the steam flow path (for example, between turbine stages).

In the exemplary embodiment, the acoustic pressure sensors or array of sensors may be of the fiber-optic type. A light source, such as a laser, can be used to send a light signal through the fiber-optic cables and the reflected light spectrum can be detected to measure the acoustic pressures.

The measured acoustic pressures are generated by ambient noise only, i.e., no active outside noise source is used (unlike many of the ultrasound based flow measurement techniques). The acoustic pressure signals and information relating to sensor locations are utilized to measure the speed of sound of the vapor-water mixture. Since the composition of the steam vapor-water mixture is directly related to the speed of sound of the mixture, the quality of the steam can be readily computed.

It is another feature of the invention to continuously monitor the steam quality either locally or at remote locations via online connection.

Accordingly, the present invention relates to a method of determining wetness fraction of steam vapor-water mixture in a flow path of a steam turbine comprising: a) locating a plurality of acoustic pressure sensors at axially spaced locations along the flow path; b) measuring acoustic pressures from noise in the flow path; c) calculating the speed of sound of the vapor-water mixture; and d) calculating the mass fraction of water in the mixture from the speed of sound of the mixture.

In another aspect, the present invention relates to a method of determining wetness fraction of a steam vapor-water mixture in a steam flow path in a steam turbine comprising: a) locating a plurality of fiber-optic based acoustic pressure sensors at axially spaced locations along the steam flow path; b) measuring acoustic pressures from ambient noise in the flow path; c) calculating the speed of sound of the vapor-water mixture; d) calculating the mass fraction of water in the mixture from the speed of sound of the mixture; and e) continuously monitoring at least steps b) through d).

The invention will now be described in detail in connection with the drawings described below.

### BRIEF DESCRIPTION OF DRAWINGS

FIG. 1 is a cross section of a low pressure section of a steam turbine, indicating acoustic pressure sensors placed along the periphery of the exhaust and/or in different radial positions in accordance with the invention.

### DETAILED DESCRIPTION

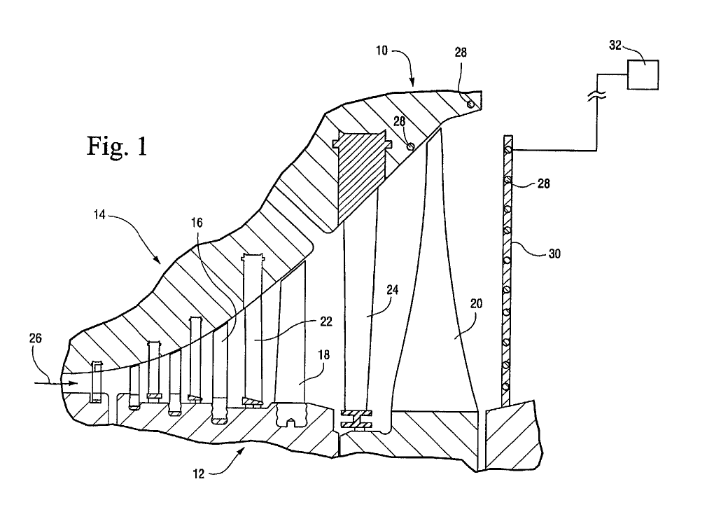

Referring to FIG. 1, a portion 10 of a low pressure section of a steam turbine is illustrated, including a rotor 12 and a diaphragm 14. A plurality of turbine buckets, for example, 16,18 and 20 are attached for rotation with the rotor, while a plurality of stationary nozzles, for example, 22,24 are supported in the diaphragm 14. The steam flow path is oriented from left to right as indicated by the flow arrow 26.

In accordance with this invention, a plurality of acoustic transducers or sensors 28 may be placed at axially spaced locations anywhere along the steam path including along the periphery of the turbine exhaust. Alternatively, an array of such sensors may be supported in different radial positions along a radially oriented internal probe 30 as also shown in the Figure. In fact, the sensors may be located anywhere along the steam flow path, e.g., between stages, at the steam inlet, steam exhaust, etc.

In the preferred embodiment, the acoustic sensors are of the fiber-optic type available from the CiDRA Corporation of Wallingford, Conn. These sensors and the manner in which the speed of sound of a two-phase medium is calculated and used to also determine the mass fraction of water in the mixture is disclosed in U.S. Pat. No. 6,354,147, the entirety of which is hereby incorporated by reference. This same technique is employed to measure the mass fraction of water in the water-vapor mixture of the steam in the steam flow path of the turbine. Once the wetness fraction is known, the steam quality (vapor fraction) can be readily ascertained. The above technique for measuring steam quality is also amenable to continuous online monitoring via, for example, a computer 32 at a remote location.

While the invention has been described in connection with what is presently considered to be the most practical and preferred embodiment, it is to be understood that the invention is not to be limited to the disclosed embodiment, but on the contrary, within the spirit and scope of the appended claims, is intended to cover various modifications and equivalent arrangements in the steam turbine field.

1. A method of determining wetness fraction of steam vapor-water mixture in a flow path of a steam turbine comprising:
a) locating a plurality of acoustic pressure sensors at axially spaced locations along the flow path;
b) measuring acoustic pressures from noise in the flow path;
c) calculating the speed of sound of the vapor-water mixture; and
d) calculating the mass fraction of water in the mixture from the speed of sound of the mixture.

2. The method of claim 1 wherein said acoustic pressure sensors comprise fiber-optic based sensors.

3. The method of claim 1 wherein said sensors do not intrude on the flow path.

4. The method of claim 1 wherein said noise comprises ambient noise only.

5. The method of claim 1 and further comprising online monitoring of steps b) through d).

6. The method of claim 1 wherein, in carrying out step a) at least some of said plurality of sensors are located radially, between adjacent turbine stages.

7. The method of claim 1 wherein, in carrying out step a), said plurality of sensors are located in a turbine casing component along a periphery of the steam flow path.

8. A method of determining wetness fraction of a steam vapor-water mixture in a steam flow path in a steam turbine comprising:
a) locating a plurality of fiber-optic based acoustic pressure sensors at axially spaced locations along the steam flow path;
b) measuring acoustic pressures from ambient noise in the flow path;
c) calculating the speed of sound of the vapor-water mixture;
d) calculating the mass fraction of water in the mixture from the speed of sound of the mixture; and
e) continuously monitoring at least steps b) through d).

9. The method of claim 8 wherein said sensors do not intrude on the flow path.

10. The method of claim 8 wherein said acoustic pressure sensors are located in a turbine casing component, along an exhaust section of the steam turbine.

11. The method of claim 8 wherein at least some of said acoustic pressure sensors are located between adjacent stages of the steam turbine.
